(19) United States
(12) Patent Application Publication
(10) Pub. No.: US 2024/0413436 A1
(43) Pub. Date: Dec. 12, 2024

(54) Solid State Energy Storage Devices Monolithically Printed from Dispersions

(71) Applicant: Northeastern University, Boston, MA (US)

(72) Inventors: Ahmed Mostafa Hafez ABDELAZIZ, Boston, MA (US); Ahmed BUSNAINA, Needham, MA (US)

(21) Appl. No.: 18/700,384

(22) PCT Filed: Dec. 1, 2022
(86) PCT No.: PCT/US2022/051587

§ 371 Date: Apr. 11, 2024

Related U.S. Application Data
(60) Provisional application No. 63/285,071, filed on Dec. 1, 2021.
(60) Provisional application No. 63/288,049, filed on Dec. 10, 2021.

(51) Int. Cl. H01M 50/11; H01M 4/02; H01M 4/04; H01M 4/36; H01M 4/58; H01M 4/587; H01M 10/0565; H01M 10/058

(52) U.S. Cl. CPC H01M 50/11; H01M 4/0452; H01M 4/366; H01M 4/5825; H01M 4/587; H01M 10/0565; H01M 10/058; H01M 2004/028; H01M 2300/0082

(57) ABSTRACT

An all solid-state Li metal microbattery is fabricated by directed assembly-based printing of nanoparticles on a substrate, which facilitates the fabrication of all battery components, including cathode, anode, and solid electrolyte at microscale dimensions and without the need for costly and complex fabrication techniques. The porous cathode material allows polymer electrolyte to be intercalated within the cathode, resulting in a cathode-supported electrolyte membrane which enhances battery performance through superior ionic transport, low interfacial resistance between the electrolyte and the cathode, and providing electronic pathways through the cathode framework.

### CROSS-REFERENCE TO RELATED APPLICATIONS

This application claims the priority of U.S. Provisional Application No. 63/285,071, filed on 1 Dec. 2021 and entitled “Solid State Energy Storage Devices Monolithically Printed From Dispersions” and of U.S. Provisional Application No. 63/288,049, filed on 10 Dec. 2021 and entitled “Solid State Energy Storage Devices Monolithically Printed From Dispersions”. Both provisional applications are hereby incorporated by reference in their entirety.

### STATEMENT REGARDING FEDERALLY SPONSORED RESEARCH OR DEVELOPMENT

This invention was made with government support under Grant Number N66001-21-C-4055 awarded by DARPA Defense Advanced Research Projects Agency. The government has certain rights in the invention.

### BACKGROUND

The rapid development of information technology and enhancement of multifunctional, highly integrated electronic devices has opened new opportunities for wireless networks in different applications such as wearables, flexible electronics, biomedical sensors, environmental monitoring, smart home devices, asset monitoring, and transport surveillance^{1 2}. Such electronic devices are capable of deploying large numbers of autonomous microsensors, actuators, microrobots and other microdevices that normally collect, process, and exchange data with other devices through local networks³. The power demands of these distributed devices combined with their confined micro size are driving significant interest in rechargeable microbatteries with energy and power densities greater than what can be achieved using conventional thin film batteries⁴⁻¹⁰. However, reducing the battery dimensions introduces major challenges; as the battery size shrinks, the traditional fabrication processes for composite electrodes and the use of liquid electrolytes become increasingly incompatible. In addition, liquid electrolytes usually carry inherent risk of leakage and becoming ignitable, which raises safety concerns. Moreover, the parasitic weight of the conventional miniaturized batteries significantly increases due to the implementation of traditional fabrication methods that keep the parasitic packaging weight significantly large compared to the battery active materials¹¹. As a result, the need for all solid-state microbatteries is vital for reliability and stability for microbattery production, which can facilitate miniaturization, provide more flexibility on the design of stand-alone microelectronic devices, and eliminate the safety concerns of liquid electrolyte leakage. Accordingly, the design architecture of microbatteries should differ greatly compared to their bulk-size counterparts, which signifies the need for more innovative fabrication procedures as well as novel architectures for electrodes and cell design^{4, 12, 13}. Currently, most fabrication techniques involve the utilization of sacrificial templates in order to achieve compact and microscale resolution for the electrodes. Although such methods show more reliability and adequate battery performance compared to other techniques such as inkjet or screen printing, sacrificial templates that are commonly used can significantly increase the complexity of the fabrication process, which hinders its large-scale production and increases manufacturing costs.

Although less complicated techniques such as inkjet printing have frequently been adopted, the inks used usually imply a high percentage of organic components and/or surfactants that are required to achieve suitable ink consistency. These additives hinder the battery performance since they are not contributing to the charge/discharge process. Also, for micro-electrode preparation, traditional curing processes introduce cracks into the electrodes and instability for the solid electrolyte interface during cycling. For these reasons, a new and scalable approach is crucially needed to match the gap between the simplicity of microbattery fabrication on a large scale, and the reliability of the battery performance over long-term cycling, which should pave the way for commercial applications.

### SUMMARY

The present technology provides an all solid-state microbattery which can be fabricated by directed assembly-based printing of nanoparticles on a substrate, which facilitates the fabrication of all battery components, including cathode, anode, and solid electrolyte at microscale dimensions and without the need for costly and complex fabrication techniques such as high energy vacuum deposition techniques, elevated curing temperatures, or complicated sacrificial templates. The resulting porous cathode material allows polymer electrolyte to intercalate within the cathode material, resulting in a cathode-supported electrolyte membrane which enhances battery performance through superior ionic transport, low interfacial resistance between the electrolyte and the cathode, and providing electronic pathways through the cathode framework. The present fabrication technology also can be used to produce supercapacitors or other energy storage devices.

A “microbattery” as used herein can be any small battery, such as a battery having one or more dimensions of 1 cm or less, or a battery having any component with one or more dimensions of 1000 microns or less. A battery or microbattery of the present technology can have any form, such as a coin cell, button cell, pouch cell, thin film, and can be flexible or inflexible. Batteries and microbatteries of the present technology can be used in any electronic device requiring such a battery, such as a medical device, a hearing aid, earbuds, a sensor for home, commercial, or agricultural use, a smoke detector, a heat sensor, a moisture or humidity sensor, a thermometer, a toy, an article of clothing, an electrical device that is part of the Internet of Things (IoT), a light, a computer, a display device, a phone, a musical instrument, or a microphone, for example. Batteries or microbatteries of the present technology preferably are rechargeable, but also can be disposable or single use.

The technology can be further summarized in the following list of features.
1. A solid state battery comprising:
   (i) an electrically insulating substrate;
   (ii) first and second conductive contact layers deposited on the substrate, the first contact layer having a first pattern, and the second contact layer having a second pattern;
   (iii) a cathode layer deposited on the first contact layer and conforming to the first pattern;
   (iv) an anode layer deposited on the second contact layer and conforming to the second pattern;
   (v) a solid electrolyte supported by the cathode layer, wherein the cathode layer is infiltrated with the solid electrolyte.
2 The battery of feature 1, wherein the first and second patterns are interdigitated.
3. The battery of feature 1 or feature 2, wherein the cathode layer is a composite comprising carbon coated lithium iron phosphate (CLiFePO₄) nanoparticles or microparticles embedded in a polymer matrix.
4. The battery of feature 3, wherein the polymer matrix comprises polypyrrole (PPy) or a derivative thereof.
5. The battery of any of the preceding features, wherein the anode layer comprises a metal selected from the group consisting of lithium, zinc, and nickel.
6. The battery of any of the preceding features, wherein the solid electrolyte comprises polyethylene oxide.
7. The battery of any of the preceding features, wherein the first and/or second conductive contact layers comprise a metal or metal alloy selected from the group consisting of gold, gold alloys, and nickel/gold alloys.
8. The battery of any of the preceding features, wherein the substrate comprises silicon dioxide, glass, silicon, or a non-conductive polymer.
9. The battery of any of the preceding features, wherein the substrate is flexible or rigid.
10. The battery of any of the preceding features that is a microbattery.
11. The battery of any of the preceding features that is rechargeable for at least 200 charging cycles with loss of not more than 30%, not more than 25%, not more than 20%, not more than 15%, not more than 10%, not more than 5%, not more than 2%, or not more than 1% of its original capacity.
12. The battery of any of the preceding features, wherein the first and second contact layers comprise a NI/Au alloy, wherein the first and second patterns are interdigitated, wherein the cathode layer comprises carbon coated lithium iron phosphate (CLiFePO₄) nanoparticles or microparticles embedded in a PPy polymer matrix, wherein the anode layer comprises lithium metal, and wherein the solid electrolyte comprises polyethylene oxide.
13. The battery of any of the preceding features, wherein the battery has a discharge capacity of at least about 157 mA h g⁻¹ at 35° C. and a cycling stability of at least about 78% capacity retention and 99.7% coulombic efficiency after 200 cycles.
14. An electronic device comprising the battery of any of the preceding features.
15. The electronic device of feature 14 which is a sensor, a biosensor, a biomedical sensor, an RFID tag, a device for use in the Internet of Things, a wearable electronic item, a flexible electronic device, or a micro actuator.
16. A method of fabricating a solid state battery, the method comprising the steps of:
   (a) depositing first and second interdigitated conductive contact layers onto a surface of an insulating substrate, the first contact layer having a first pattern, and the second contact layer having a second pattern;
   (b) depositing a self-assembling monolayer onto the substrate at exposed areas not covered by the first and second conductive contact layers;
   (c) depositing a cathode layer onto the first conductive contact layer by electrodeposition using cyclic voltammetry to form a cathode;
   (d) removing the self-assembled monolayer;
   (e) depositing an anode film onto the second conductive contact layer by electroplating to form an anode;
   (f) depositing a solid electrolyte layer by dip coating the structure resulting from (e) in a suspension of solid electrolyte particles and drying the resulting covered structure to form the solid state battery, whereby a portion of the solid electrolyte particles become embedded in the cathode layer.
17. The method of feature 16, wherein the first and second patterns are interdigitated.
18. The method of feature 16 or feature 17, further comprising, between steps (a) and (b):
   (a1) silanizing said substrate surface on all areas outside of the first and second contact layers.
19. The method of feature 18, wherein the self-assembled monolayer comprises an alkyl-terminated silane.
20. The method of any of features 16-19, wherein the self-assembled monolayer is removed in step (d) by exposure to an oxygen plasma.
21. The method of any of features 16-20, wherein the solid electrolyte layer forms continuous contact with the entire surface of the cathode layer and the entire surface of the anode layer and fills spaces between the cathode and the anode to form a completely solid structure.
22. The method of any of features 16-21, wherein the electrodeposition of step (c) comprises use of an electrolyte solution comprising carbon coated LiFePO₄ nanoparticles, pyrrole monomer, and lithium perchlorate.
23. The method of any of features 16-22, wherein step (e) comprises electroplating lithium metal onto the second conductive contact layer.
24. The method of any of features 16-23, wherein the suspension of solid electrolyte particles in step (f) comprises polyethylene oxide nanoparticles suspended in acetonitrile.

### BRIEF DESCRIPTION OF DRAWINGS

FIGS. 1A-1F show a schematic illustration of a fabrication procedure for a solid microbattery. FIG. 1A shows Ni/Au interdigitated contact deposition on glass. FIG. 1B shows SAM layer formation over the surface. FIG. 1C shows cathode electrode deposition using cyclic voltammetry, FIG. 1D shows SAM removal to facilitate the deposition of Li metal anode and solid-state electrolyte. FIG. 1E shows Li metal electroplating. FIG. 1F shows solid-state electrolyte deposition using dip coating.

FIG. 2A-2G show cathode microelectrode characterization. FIG. 2A shows an SEM image for the C—LiFePO4/PPy interdigitated cathode composite. FIG. 2B shows a higher magnification SEM image for the cathode electrode. FIG. 2C shows a cross-sectional image for the electrode. FIG. 2D shows a higher magnification cross-sectional SEM image for a C—LiFePO4/PPy cathode electrode. FIG. 2E shows a TEM image for the cathode network. FIG. 2F shows EDS mapping for the cathode network where iron, phosphorus, oxygen, and carbon are represented in different shadings. FIG. 2G shows the carbon distribution across the network. FIGS. 2H and 2G show iron and phosphorus elemental distribution, respectively.

FIGS. 3A-3E show aspects of a Li metal anode plating process. FIG. 3A shows the voltage profile of Li metal deposition onto Ni/Au and Ni only electrodes. FIG. 3B shows SEM images for the plated Li metal anode and LiFePO₄/PPy cathode micro electrodes. FIGS. 3C and 3D show schematic illustrations of the electrode surface morphology for Au/Ni and Ni only contacts, respectively. FIG. 3E shows SEM images for the plated Li metal electrode formed on Ni/Au contacts, and FIG. 3D shows SEM images for the plated Li metal electrode formed on Ni only contacts.

FIGS. 4A-4D show a solid state electrolyte dip coating process. FIG. 4a shows a schematic illustration of the dip coating process for the PEO composite SSE. FIG. 4B shows a cross-sectional SEM image for the cathode electrode after electrolyte dip coating. FIG. 4C shows a high magnification cross-sectional SEM image for the cathode electrode. FIG. 4D shows a schematic illustration of the intercalated SSE electrolyte inside the electrode structure.

FIGS. 5A-5F show the electrochemical performance for microbattery fabricated according to the present technology. FIG. 5A is a photo of the battery after fabrication. FIG. 5B shows a cross-sectional schematic representation of a microbattery cell. FIG. 5C shows Nyquist plots for cathode supported and separate membrane microbatteries. FIG. 5D shows voltage profiles for a cathode-supported cell. FIG. 5E shows a rate capability test under various rates from 0.1 to 1 C. FIG. 5F shows coulombic efficiency for both cathode-supported and separate membrane cell.

FIG. 6 shows cyclic voltammetry curves for in-situ deposition of CLiFePO₄/PPy composite cathode.

FIG. 7 shows thermogravimetric analysis (TGA) performed for 4 different C—LiFePO₄/PPy ratios. Each composite was heated to 750° C. at argon atmosphere with a rate of 1° C./min and maintained for 4 hrs. at 750° C., then cooled down to room temperature at a rate of 20° C./min.

FIG. 8 shows X-ray diffraction spectroscopy (XRD) for the deposited cathode electrode. The patterns show that the cathode consists of LifePO₄—C composite and forms a pure orthorhombic system with olivine-crystal structure (Pnma, JCPDS: 40-1499).

FIG. 9 shows voltage profiles for the separate membrane microbattery at a temperature of 45° C. The specific capacity was calculated as 89.5, 60, 42.5, and 28.2 mAh g⁻¹ at 0.1 C, 0.2 C, 0.5 C, and 1 C, respectively.

### DETAILED DESCRIPTION

Recent demand for tiny electronic devices requires the development of miniaturized rechargeable batteries that can provide power and energy needs for various applications such as flexible wearable electronics and wireless sensor networks. Microbatteries have been investigated as a reliable route for achieving this target; however, in order to reach a reliable performance of such batteries while reducing the size and minimizing the fabrication cost, more sophisticated architectures need to be achieved. The present technology provides a novel approach to fabricate an all solid-state Li metal microbattery based on the directed assembly-based printing of nanoparticles. This unique approach facilitates the assembly and fabrication of all battery components including cathode, anode, and electrolyte at microscale dimensions, without the need for implementing costly and complex fabrication techniques, such as sacrificial templates. The term “microscale dimensions” as used herein refers to structures having any one or more dimensions measuring in the range from 1 micrometer to 1000 micrometers in size. Moreover, the porous cathode framework obtained using this approach provides enough space for a polymer electrolyte to be infiltrated within the cathode, resulting in a cathode-supported electrolyte membrane. This drastically enhances the battery performance through combining superior ionic transport and low interfacial resistance between the electrolyte and the cathode, as well as providing excellent electronic pathways through the cathode framework.

Results show that an as-fabricated LiFePO₄/Li solid state battery of the present technology has outstanding performance with discharge capacity of 157 mA h g⁻¹ at 0.1 C, and a long-term cycling stability of 99.7% coulombic efficiency with a capacity retention of 89.5% after 200 cycles. The EIS measurements also revealed a lower interfacial resistance for the cathode-supported electrolyte microbattery compared to its separated membrane counterpart, which further explains their outstanding performance. The unique fabrication approach of the present technology paves the way for mass production of high performance all solid-state microbatteries based on Li metal anodes, and extend their application in miniaturized energy devices at low cost.

The present directed assembly method has been implemented to print different materials with metallic, semiconducting, or insulating properties on both flexible and rigid substrates¹⁴⁻¹⁷. The present technology utilizes an approach for fabricating the cathode electrodes that was introduced previously by Goodenough et al¹⁸⁻²⁰, which replaces the binder materials (such as polyvinylidene fluoride, PVDF) as well as conductive carbon particles (such as acetylene black, Ketjen black, etc.), with a polymer network, such as a polypyrrole (PPy) network, bonded to carbon-coated cathode material. By adopting this technique, the fabrication of the electrodes can be accomplished with sub-micron precision using simple electrochemical methods. This facilitates the fabrication of the battery components, including anode, cathode, and electrolyte, without using high energy vacuum deposition techniques, elevated curing temperatures, or complicated sacrificial templates. This technique also significantly minimizes the processing steps that are critically required for large scale production.

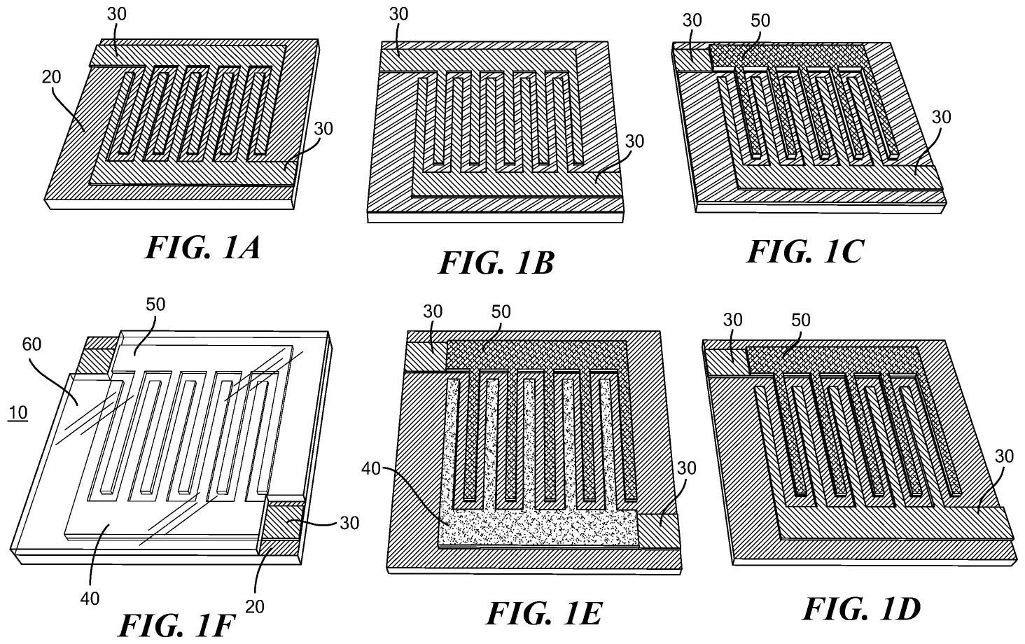

A schematic of an embodiment of a microbattery fabrication is illustrated in FIGS. 1A-1F. First, Ni/Au interdigitated contacts were deposited on a transparent glass substrate using E-beam evaporation as shown in FIG. 1A. Subsequently, surface functionalization was conducted on the glass substrate by exposing the glass substrate to silane vapor inside a vacuum oven (FIG. 1B), converting the glass surface outside the Ni/Au contacts to a hydrophobic surface. This process allows the formation of a self-assembled monolayer (SAM) and changes the surface properties to become highly hydrophobic. On the other hand, the SAM layer doesn't alter the surface properties of the Ni/Au contacts, resulting in a chemically heterogeneous surface, where the glass surface becomes highly hydrophobic except for the Ni/Au contact regions. This step is important to restrict the deposition of cathode material only onto the designated Ni/Au contacts, without leaving any residues in-between the electrodes that may lead to short circuit problems and performance instability. After that, a carbon-coated lithium iron phosphate (C—LiFePO₄) composite cathode was electrochemically deposited at one side of the interdigitated contacts as shown in FIG. 1C. After the deposition of the cathode, the SAM layer was removed by exposing the glass substrate to oxygen plasma for 3 seconds (FIG. 1D), which is sufficient to remove the SAM layer without affecting the deposited cathode material. Subsequently, a Li metal anode was electroplated inside a glove box (FIG. 1E), where the Ni/Au anode contacts were used as working electrode and Li metal was used as both counter and reference electrode. Finally, polyethylene oxide (PEO) based solid-state electrolyte was deposited on the glass substrate using dip-coating, by which the cell electrodes as well as interspacing between them were thoroughly coated by the polymer electrolyte to yield the full structure of microbattery 10 (FIG. 1F), having substrate 20, electrical contacts 30, anode 40, cathode 50, and solid electrolyte layer 50. These steps will be further explained below. The same concept is still valid for flexible substrates and can be implemented to achieve fully flexible solid state microbatteries.

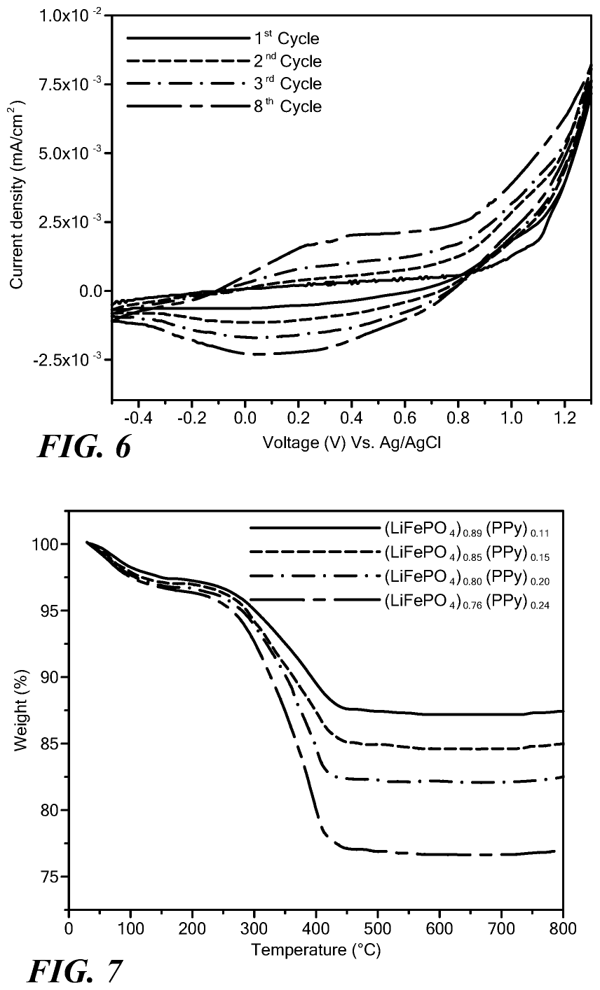

In order to fabricate the cathode electrode, a carbon coated lithium iron phosphate (CLiFePO₄)/polypyrrole (PPy) electrodeposition technique was conducted, which is based on a similar concept reported previously¹⁹. In this method, one side of the Ni/Au coated substrate was utilized as working electrode in a 3-electrode electrochemical cell, where a Pt film, and Ag/AgCl were implemented as counter and reference electrodes, respectively. FIG. 6 shows the typical cyclic voltammetry curves used for the in-situ deposition of the C—LiFePO₄/PPy composite cathode on the interdigitated Au electrode. This is in agreement with pyrrole electrodeposition previously reported under similar experimental conditions²¹. The oxidation of the pyrrole starts at 0.8 V when the monomer starts to deposit as a dark film on the Au substrate, then the film deposition proceeds with more cycling. The results show that the polymerization at the first cycle differs from successive polymerization cycles, as it reveals higher oxidation voltage at around 0.95 V compared to 0.8 V oxidation voltage for other cycles. This is attributed to the nucleation and growth initiated at the beginning of the process. Also, the oxidation/reduction current of the pyrrole monomer continuously increases with successive cycles, which can be ascribed to better pyrrole oxidation on the Au substrate enhanced by the freshly deposited PPy layer in each cycle²². During the oxidation cycle, the C—LiFePO₄ particles are entrapped within the mass of polymerizing pyrrole and are thus bound to the Au interdigitated electrode forming a porous network. This cathode network electrode provides a strong physical redox couple between PPy and C—LiFePO₄ that is incorporated inside its polymer matrix. Also, the use of carbon coated LiFePO₄ allows anchoring of the PPy with the cathode particles to the current collector²⁰. On the other hand, the conducting PPy eliminates the need of using carbon-black and polymer binder additives that are electrochemically inactive materials, and have drawbacks of reducing energy and power densities of the corresponding electrodes^{18, 23}.

In order to achieve good and uniform mixing between CLiFePO₄ and PPy, different composition ratios were tested to find the best combination that gives robust cathode film formation with best electrochemical performance. FIG. 7 shows thermogravimetric analysis (TGA) performed for 4 different C—LiFePO₄/PPy ratios. For each sample, the composite was heated at 750° C. for 4 hrs in argon atmosphere with a ramping rate of 1° C./min, then cooled down to room temperature at a rate of 20° C./min. As shown in the curve, increasing the temperature of the composite led to a weight loss that started at ˜ 200° C., which is attributed to the decomposition of PPy. Then it continued between 200-450° C. and stabilized after that with no further weight loss observed at higher temperatures, which indicates total decomposition for PPy. The weight loss was used to determine the PPy content on each sample. The 4 different samples gave weight loss of 11.4%, 15.1%, 20.5%, and 24.3%, respectively. The sample with 15.1% weight loss, corresponding to (LiFePO4)_{0.85}(PPy)_{0.15}, gave the best film assembly and most uniform deposition.

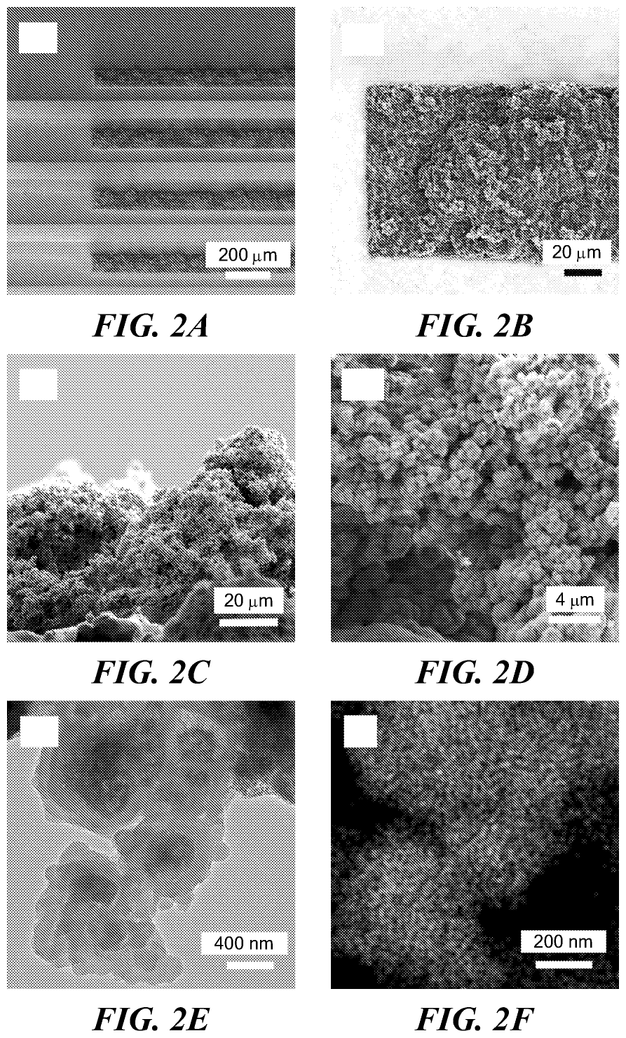

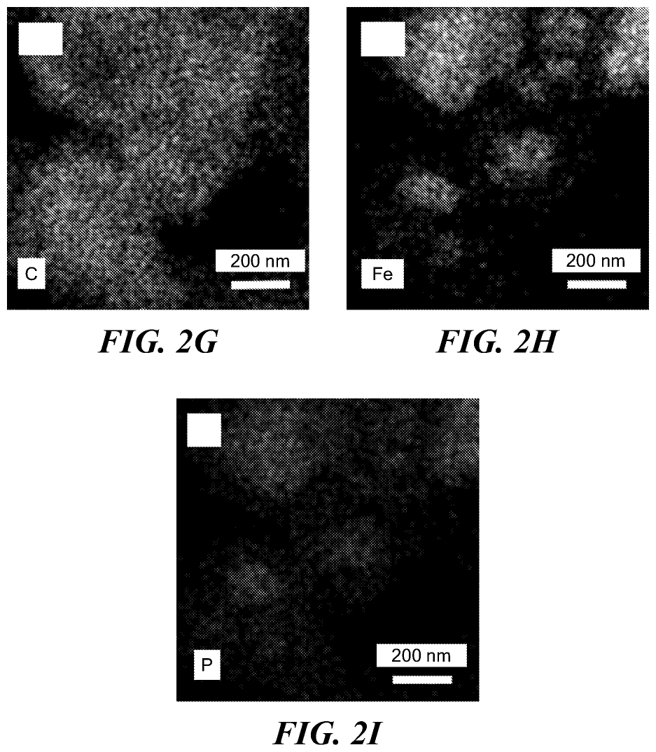

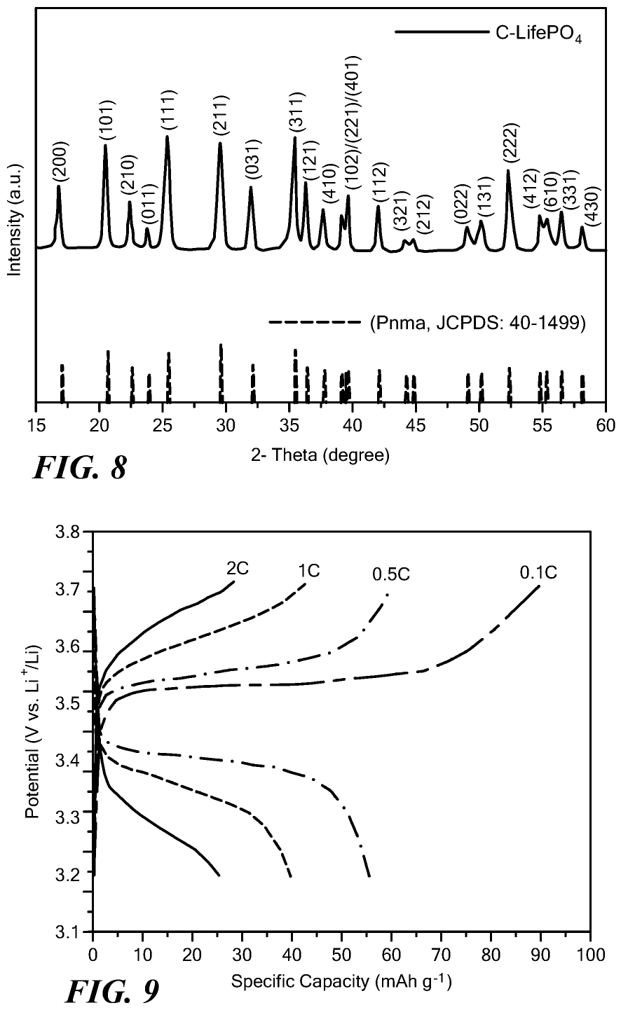

FIG. 2A shows a scanning electron micrograph (SEM) of the interdigitated electrodes after depositing C—LiFePO₄/PPy composite on the Ni/Au contacts. The cathode electrodeposition reveals uniform and precise formation over the 100 μm size electrodes, which is critically important for achieving high deposition yield for the cathode material and stable battery performance. This is attributed to the preference of the CV electrodeposition technique in the formation of uniform films and the feasibility to control the nucleation process, morphology, deposited layer thickness, as well as superior electrochemical performance of the cathode material compared to other electrodeposition methods such as chronopotentiometry and chronoamperometry²⁴. FIG. 8 shows X-ray diffraction spectroscopy (XRD) for the deposited film, the patterns reveal that the cathode electrode consists of LiFePO₄—C composite and has a pure orthorhombic system with olivine crystal structure (Pnma, JCPDS: 40-1499). It should be noted that no carbon phase from polypyrrole was observed, which is believed to be attributed to amorphous structure of the polypyrrole network²⁵. The results confirm the crystal structure of the deposited LiFePO₄—C composite film²⁶.

FIG. 2B shows a high magnification SEM image of the cathode electrode. A dense film can be observed with accurate printing definition over the interdigitated electrode. The density and thickness of the film can be controlled using the CV deposition parameters, such as potential window, sweeping voltage rate, as well as the number of deposition cycles. This gives more feasibility for the CV process to form desired film morphology for different cathode materials^{27,28}. FIG. 2C shows a cross-section SEM image of the formed cathode. A compact film of dense C—LiFePO₄ particles can be observed with a network of PPy firmly connecting the particles together. The average film thickness was found to be 25 μm across the electrode. Different thicknesses can be achieved based on the CV parameters implemented during deposition. The high magnification SEM image of the C—LiFePO₄/PPy electrode in FIG. 2D reveals the cathode network and the C—LiFePO₄ particles in more detail. The particle size was found to be 200 nm on average, and the particles were connected in a network within the PPy matrix. This composite network structure strongly influences the morphological and electrochemical performance of the cathode. The PPy firmly connects the C—LiFePO₄ particles together to form a robust film with good adhesion to the substrate, while it provides an optimum electrical conductivity for the charge carriers throughout the cathode electrode during the charge/discharge process of the microbattery.

Since the PPy network is difficult to observe in SEM images, transmission electron microscopy (TEM) was utilized to obtain clear insight into the cathode formation and its composition. FIG. 2E shows a TEM image of the cathode network, in which a grape vine-like structure of C—LiFePO₄ particles can be observed, which are intimately connected to the PPy 20) network. This morphology further confirms the dual vital role that the PPy network plays in the cathode composition by firmly connecting the active cathode materials and supporting pathways for the charge carrier during charging/discharging. Moreover, this structure eliminates the need to use inactive materials such as conductive carbon particles and other binding polymers. In order to confirm the elemental composition of the cathode network, energy dispersive X-ray spectrometer (EDS) mapping of the grape vine-like structure was conducted. FIG. 2F exhibits a mixed colored map that shows oxygen elements in one shading and carbon in a different shading (original map used different colors, not shown). The mapping reveals C—LiFePO₄ particles homogeneously distributed and connected thoroughly within the PPy network. FIG. 2G shows carbon elemental distribution only, which is referable to the PPy network²⁹. FIGS. 2H and 2I reveal the elemental distribution of Fe and P, respectively, which are attributed to the C—LiFePO₄ particles inside the PPy network.

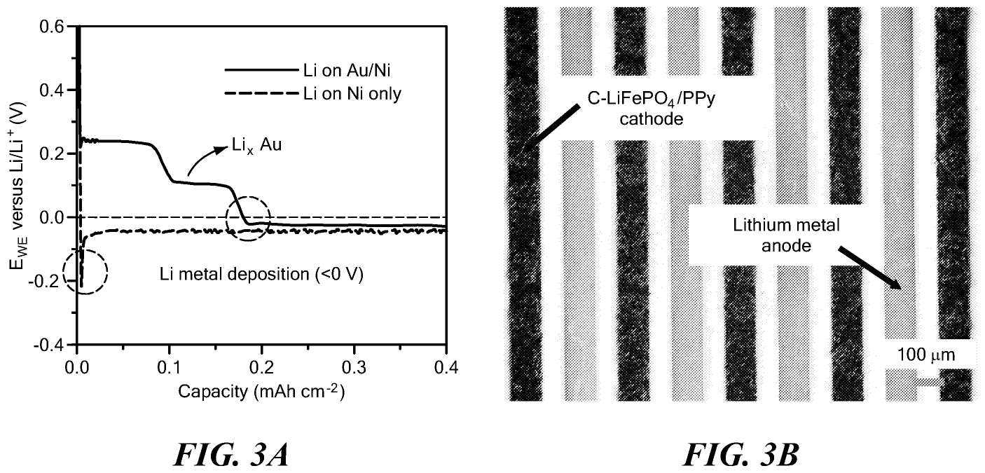

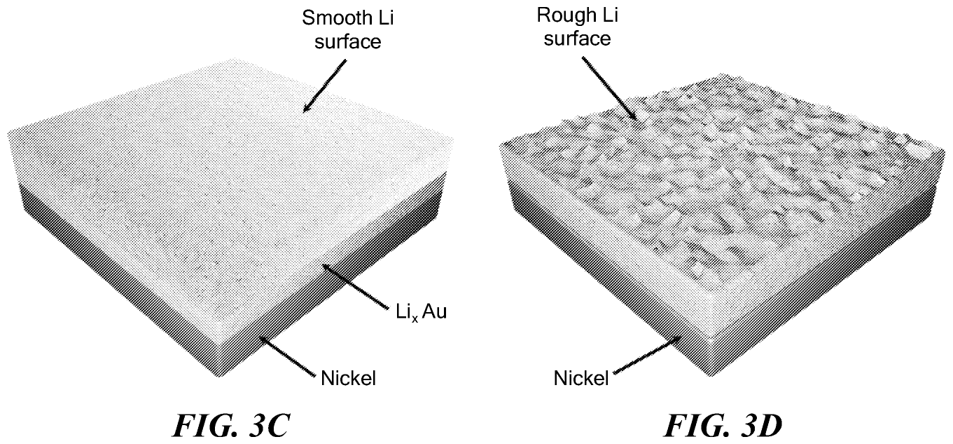

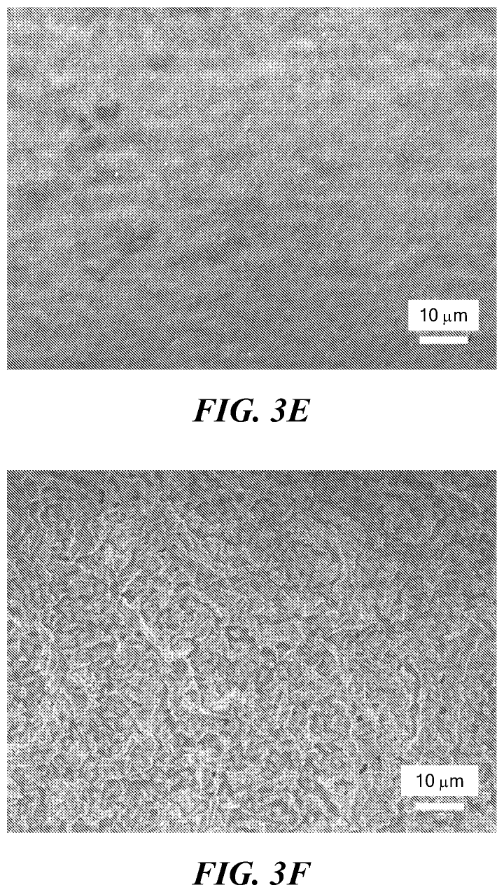

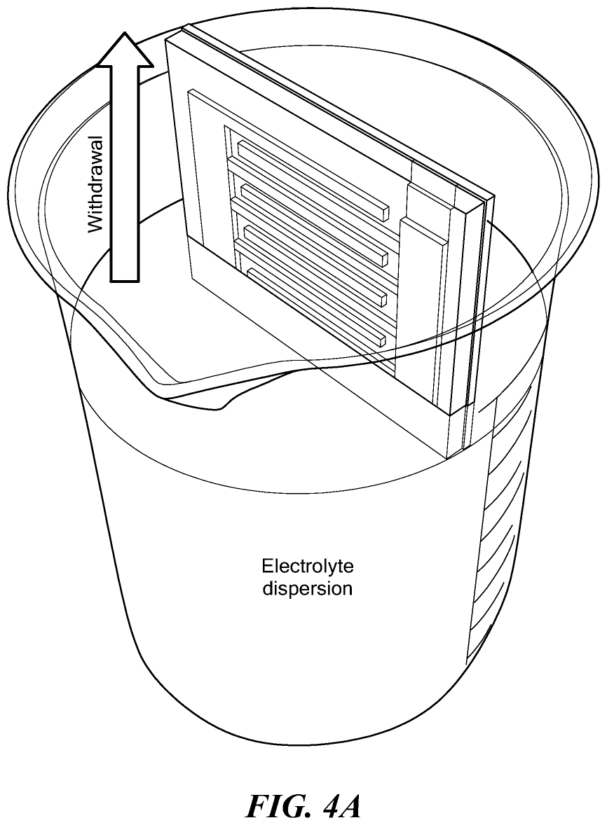

As described above, cathode fabrication and composition were investigated using electrodeposition. In this section, the fabrication of the anode is discussed in more detail. The Li metal pre-lithiation has been implemented to form a stable Li metal anode on the interdigitated Ni/Au electrode. Li metal was selected as the anode for the microbattery because of its high specific capacity (3861 mAh g⁻¹) as well as its electrochemical potential (−3.04 V versus standard hydrogen electrode), which can fulfill the increasing requirements of high energy density microbatteries³⁰⁻³³. However, a different battery chemistry also can be used, in which case a metal can be chosen for the anode which is consistent with that chemistry. In addition, it is also feasible to take advantage of the precise control on the electrodeposition technique to form confined and uniform micro-scale Li metal anode from Li salt suspensions. On the other hand, the utilization of a Li metal anode is hindered by the uncontrolled growth of Li dendrites, which is mainly caused by the instability of its solid electrolyte interface (SEI) and the uneven nucleation during Li plating/striping process³⁴⁻³⁷. Alleviation of Li dendrite formation can be achieved through Li metal alloying, which guides uniform Li deposition and forms stable and robust SEI during plating/stripping^{38, 39}. In this approach, metals such as Au, Ag, and Pt are used as sacrificial layers to form a solid solution alloy with Li metal before actual deposition of pure Li metal phase. This solid solution surface layer serves as a buffer layer for subsequent Li deposition³⁸. A similar approach has been implemented in the present technology using a pre-deposited Ni/Au interdigitated electrode, where the Au film acts as a sacrificial layer that alloys with Li metal and allows the formation of a uniform Li film on top of the electrode, while the Ni bottom layer acts as a back contact. FIG. 3A shows the voltage profile of Li metal deposition onto the Ni/Au electrode. The curve shows two lithiation plateaus attributed to the formation of two LiₓAu phases at positive potential versus a Li/Li⁺ reference electrode, after which pure Li metal starts to uniformly nucleate over the surface at −40 mV versus Li/Lit. After nucleation, pure Li metal was deposited on the Ni/Au electrode with a capacity of 1 mAh cm 2 at a current density of 0.2 mA cm⁻². These results are in agreement with what was reported previously for Li alloying with other metals³³. FIG. 3B presents SEM images for the plated Li metal anode microelectrodes side by side with the previously electrodeposited cathode microelectrodes. The precise deposition over the Ni/Au contacts demonstrates the feasibility of the metal alloying electrodeposition method to fabricate micro-dimensional electrodes without deterioration of the cell stability through side leakage currents. Moreover, it provides enough spacing for the electrolyte to diffuse uniformly between the electrodes to create a robust SEI layer, and uniform current density distribution across the electrode surface during charging and discharging⁴⁰.

The homogeneous nucleation in case of Ni/Au substrate can be confirmed by the absence of any Li nucleation potential at the beginning of pure Li deposition over the LiₓAu alloy. This is in contrast with the Ni substrate, where a large nucleation potential can be observed (FIG. 3A). It indicates unfavorable and non-uniform Li deposition over the Ni surface, leading to cell instability and dendrite formation during cycling. These results are also in agreement with previously reported findings by Yan et al³⁸. The schematic diagrams in FIGS. 3C and 3D further illustrate the difference in each case, where the LiₓAu layer plays a critical role in guiding a uniform fresh Li deposition on the surface, in contrast to Ni contacts only where Li nucleates directly on the Ni surface with no alloying taking place between Li and Ni. To further confirm the surface morphology, SEM images were obtained for both Li metal electrode deposited on Au/Ni contacts and Li metal coated on Ni contacts only. As shown in the SEM image in FIG. 3E, the Li metal electrode formed on Ni/Au contacts shows a smooth surface with uniform Li deposition throughout the electrode, as illustrated earlier. This is mainly attributed to the presence of a LiₓAu layer at the beginning of plating. Conversely, Li metal deposited on the Ni electrode reveals non-uniform surface with extreme surface roughness (FIG. 3F), which is attributed to the non-uniform nucleation of Li metal over Ni contacts and the random growth of Li metal film during deposition. The smooth surface achieved using Ni/Au contacts enhances cell stability by alleviating dendrite formation, and by homogenously distributing the current density over the electrode surface to form a stable surface electrolyte interface (SEI) layer³⁴.

After depositing the cathode and anode of the microbattery, the next step is to deposit the polymer electrolyte. Here, solid state electrolyte (SSE) was adopted as a replacement for non-aqueous electrolyte, as it enhances the safety profile of the microbattery. Moreover, it also helps in getting an ultrathin electrolyte thickness, which fits well with the microbattery architecture. The SSE combined with Li metal anode allows for an all-solid state Li metal battery (SSLMB) that can potentially deliver high energy density with excellent safety⁴¹⁻⁴³. However, SSE presents some challenges, including poor interfacial contact between the electrolyte and electrodes, brittleness, and manufacturing difficulty⁴⁴⁻⁴⁵. In order to alleviate these problems, the present technology takes advantage of the porosity of the deposited C—LiFePO₄/PPy cathode and utilizes a cathode-supported SSE membrane applied using a dip coating procedure. Here, polyethylene oxide (PEO) based composite SSE was selected because of its compatibility with both electrodes, particularly the Li metal anode, which (i) shows outstanding stability with various alkaline; (ii) provides good wettability and film forming features; and (iii) can be easily obtained at a low cost for large scale production⁴⁶. However, any solid state electrolyte material can be used which is consistent with the chosen battery chemistry. Preferably the precursor electrolyte material is supplied as a nanoparticle suspension suitable for deposition by the dip coating method described herein.

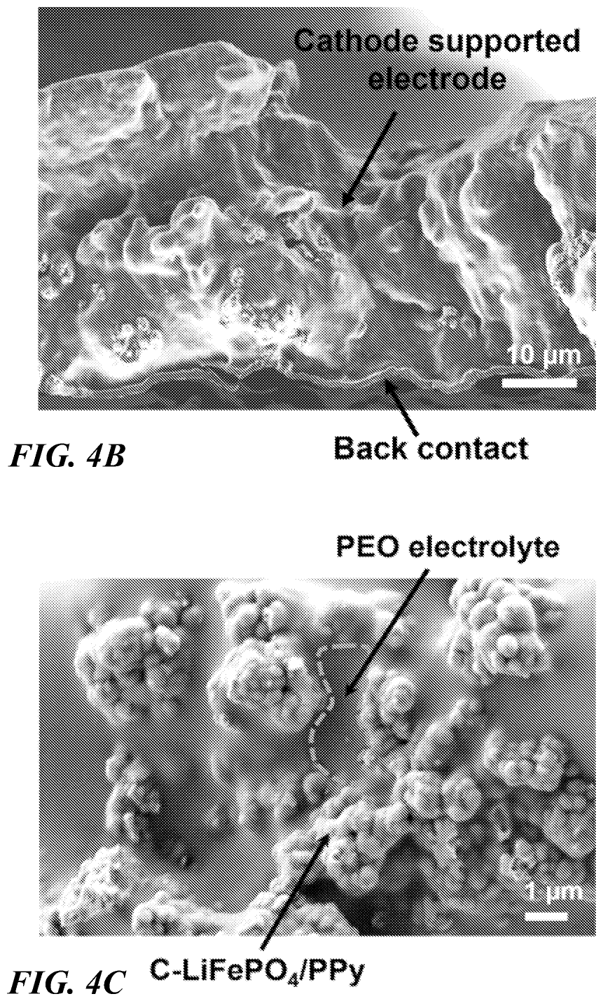

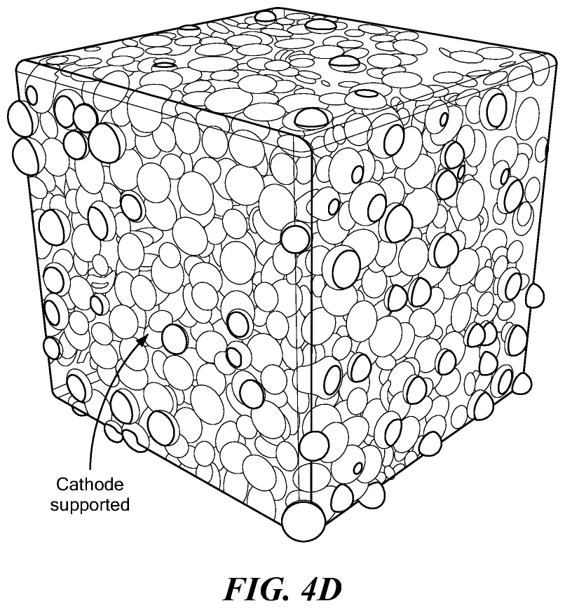

FIG. 4A illustrates the dip coating process for the solid polymer electrode. The electrode is directly dipped into a PEO composite suspension and then withdrawn at a fixed speed of 20 mm min¹ using a dip coater. Any withdrawal speed can be used that is consistent with directed assembly to form a uniform and complete coating layer and to allow intercalation of the electrolyte material within the matrix of the cathode material. This allows the SSE to deposit thoroughly within the pores of the cathode as well as the space between the cathode and anode. FIG. 4B shows a cross-section SEM image of the cathode electrode, where the C—LiFePO₄/PPy cathode is completely covered and engulfed by the SSE polymer. A high magnification cross-section SEM image for the C—LiFePO₄/PPy network after SSE coating is shown in FIG. 4C. It can be observed that the SSE shows superior wettability inside the cathode electrode, and precisely penetrates through the porous cathode to intimately cover the C—LiFePO₄/PPy network clusters with its grape-vine structure. This is mainly attributed to the capillary attraction between the cathode layer and the solid electrolyte introduced by dip coating, which significantly enhances the wettability and interfacial adhesion⁴⁶. FIG. 4D shows a schematic diagram of the intercalated SSE inside the electrode structure, creating a cathode-supported, cathode intercalated, or cathode anchored SSE electrode membrane. This design alleviates various SSE challenges compared to conventional SSE batteries which have a separate electrolyte membrane. In particular, the advantages result from: (i) reinforcing better interfacial contact by incorporating the polymer electrolyte inside the cathode framework; (ii) providing a unique mixed conducting framework by combining the high ionic conductivity of the SSE with the electrical conductivity of the PPy network throughout the cathode; and (iii) enhancing the wetting ability of the solid electrolyte through filling the pores inside the cathode electrode. After the SSE deposition, the final fabrication step to make the full microbattery is drying the cell, for example at 50° C. in an argon atmosphere overnight.

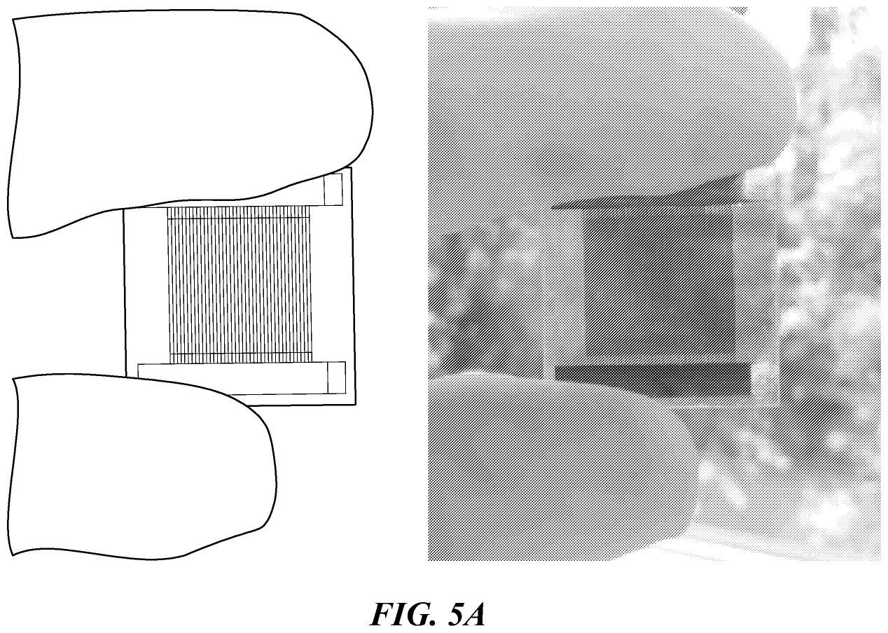

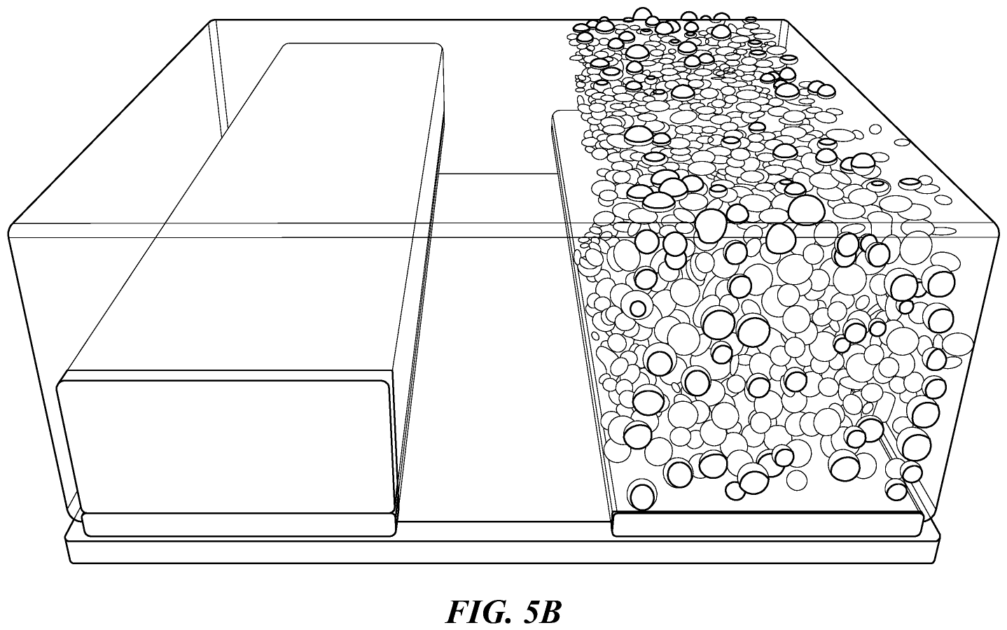

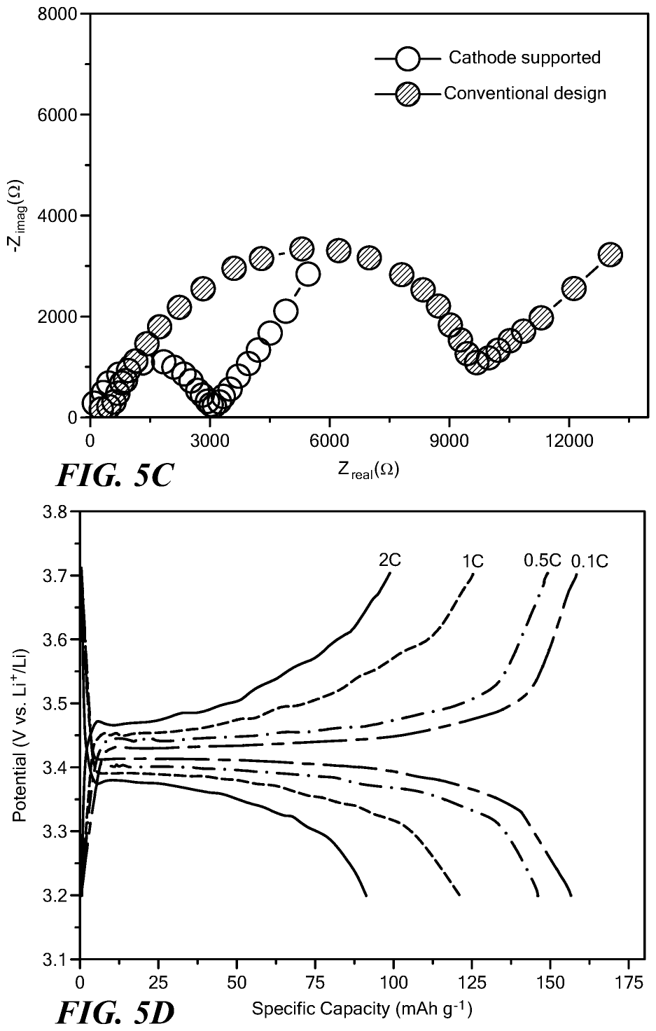

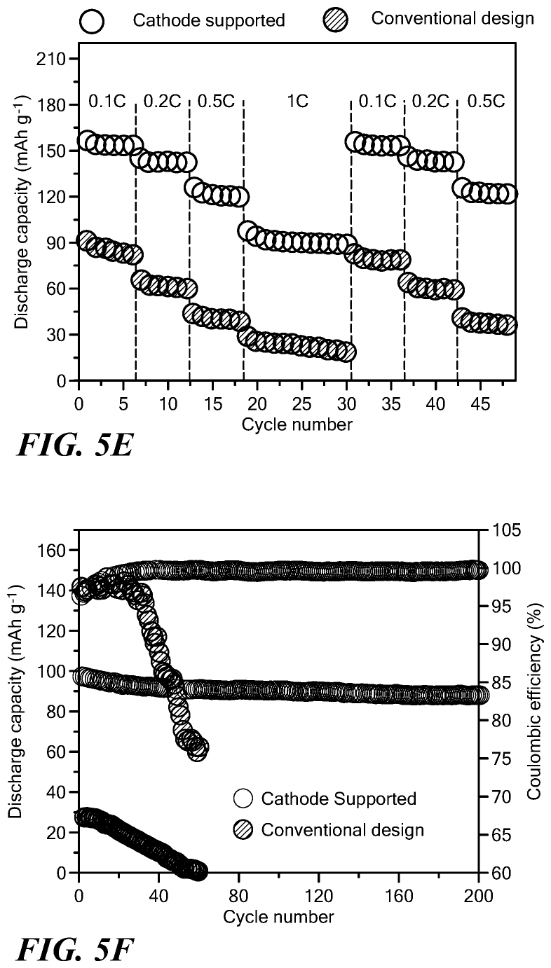

FIG. 5A shows a photograph of a microbattery after the final SSE deposition step in the fabrication process. It should be mentioned that the spacing between the electrodes can be adjusted based on the thickness required for the cathode electrodes. That is, in order to achieve a larger thickness, the spacing between the electrodes needs to be increased proportionally to provide sufficient space for thicker electrodes. Otherwise, instability in the battery performance or shorts may occur. FIG. 5B shows a schematic cross-section of the microbattery cell. As illustrated, the SSE covers the entire surface of the electrodes as well as the space between them. Moreover, the cathode-supported electrode provides outstanding continuous accessibility for the SSE throughout the cathode electrode. This provides distinct advantages for battery performance through providing uniform electrolyte distribution through the battery electrodes, which helps in building more robust and stable SEI. Also, it reduces the local current density by increasing the overall electroactive surface area of the electrodes⁴⁶.

To further verify the improvements brought about by the SSE electrolyte deposition technique on ion transport across the cell, electrochemical impedance spectroscopy (EIS) was conducted to measure the interfacial contact resistance for the cathode-supported electrode compared to conventional separate electrode battery design. The test was performed at frequencies between 10⁵ and 10⁻² Hz and under 10 mV applied oscillation voltage. For this experiment, two different designs of microbattery cells were constructed using Li/electrolyte/C—LiFePO₄-PPy, one with a cathode-supported solid electrolyte, and the other with a separate membrane electrolyte that is fabricated by applying a separate solid electrolyte membrane over the battery electrode instead of intercalating the electrolyte through the battery cathode electrode (more details are described in the experimental section). FIG. 5C shows the Nyquist plots for both microbatteries. In the case of the separate electrolyte membrane cell, a large semicircle can be observed at high frequency, which indicates large interfacial resistance at the electrode/electrolyte interfaces. This is mainly attributed to the non-uniform electrolyte distribution across the surface of the electrode and the poor wettability of the solid electrolyte through the cathode. Conversely, the cathode-supported membrane cell revealed much lower interfacial resistance as indicated by the relatively small semicircle in the Nyquist plot. This is attributed to the outstanding wettability of the electrolyte through the electrode which provides uniform electrolyte coverage and low interfacial resistance.

After finishing the fabrication process for the microbattery, its performance was examined using a full cell electrochemical charge/discharge test. FIG. 5D shows the voltage profiles for the cathode-supported microbattery at a temperature of 45° C. The specific capacity for the supported-cathode microbattery is calculated as 161 mAh g⁻¹ at 0.1 C charge/discharge rate, whereas it showed 149, 126, and 95 mAh g⁻¹ at 0.2 C, 0.5 C, and 1 C, respectively. On the other hand, the separate electrode membrane cell voltage profile (Figure S4) revealed much lower specific capacities of 89.5 mAh g⁻¹ at 0.1 C, whereas the specific capacity was 60, 42.5, and ˜ 28.2 mAh g⁻¹ at 0.2 C, 0.5 C, and 1 C, respectively. This illustrates the superior performance of the electrode-supported microbattery structure compared to other conventional cell designs with a separate electrode membrane, particularly at low operating temperature. FIG. 5E shows the results of a long term cycling stability test for the cathode-supported microbattery as well as its separate electrode membrane counterpart. The cathode-supported cell showed long term stability even after 200 cycles, with a large capacity retention of ˜78%, and a large coulombic efficiency of 99.7%, which are significantly higher than for the separate membrane design, which showed an inferior capacity retention of only 20% after 200 cycles and poor coulombic efficiency. FIG. 5F shows results of a rate capability test for each cell at different rates. The cathode-supported cell revealed stable cycling at different rates and lower hysteresis compared to its separate electrolyte membrane counterpart, which showed much lower capacity, particularly at higher charging rates (1C). This is due to the unique cell design of the supported cathode electrolyte, which provides facile pathways for Li ions to be uniformly inserted inside the cathode with even current density distribution over the electrode surface compared to the conventional separate membrane electrode cell design.

In summary, the present technology provides a novel approach to fabricate an all solid-state Li metal microbattery based on a directed assembly-based printing process and in-situ electropolymerization to monolithically print the battery's cathode, anode, and solid-state electrolyte from suspensions. The process allows the fabrication of microscale electrodes with high precision without the need of using sacrificial templates or post etching processes. The PPy polymerization inside the LiFePO₄ suspension allowed the formation of (C—LiFePO₄)/(PPy) composite network, which revealed unique morphological and electrochemical performance, where the PPy was found to firmly connect the C—LiFePO₄ particles together and form a strong adherence to the substrate, meanwhile it provides high charge carrier pathways through the cathode electrode during cycling. Furthermore, the plated Li metal anode on Au/Ni contacts showed smooth surface morphology compared to Li plated on Ni only contacts, which is attributed to the uniform deposition of fresh Li on the Au—Li phase alloy. Moreover, the SSE dip coating process showed interesting properties where the SSE successfully infiltrated inside the cathode electrode network to form a cathode-supported electrolyte electrode. The Nyquist plots confirmed the reduction of the interfacial resistance for the cathode-supported SSE battery compared to the conventional separate electrode SSE battery. Finally, electrochemical measurements revealed the outstanding performance of the fabricated microbattery with discharge capacity of 157 mA h g⁻¹ at 35° C., and long-term cycling stability of 78% capacity retention, and 99.7% coulombic efficiency across 200 cycles.

Uses of the present battery technology include providing power to tiny and flexible electronic circuits, where bulky batteries are not an option; embedding in RFID tags, and integration with devices such as wearable electronics, flexible electronics, biomedical sensors, and micro actuators.

The present technology includes several novel features not found in previous battery designs. The microbattery of the present technology is the first all solid-state microbattery that is constructed from liquid dispersions and monolithically printed on a glass substrate. The present battery design also can be applied to flexible substrates to make an entirely flexible solid-state microbattery. A cathode-supported solid electrolyte is fabricated such that it becomes intercalated throughout the cathode material, providing better charge transfer and suppressing Li dendrite formation, which in turn enhances battery safety.

The present technology also offers a number of advantages over previous battery technologies. The electrode interfacial resistance is significantly reduced compared to conventional battery design. The fabricated microbattery has a high discharge capacity of 157 mA h g-1 at 35° C. It has excellent long-term cycling stability of 78% capacity retention and 99.7% coulombic efficiency after 200 cycles. All the battery components (electrodes and electrolytes) are printed from liquid dispersions, which doesn't use high vacuum processing or complicated sacrificial templates that can't be easily applied on a large scale. Thus, the present battery production is readily scalable. Microbattery fabrication of batteries currently available in the market is quite expensive because of the complicated structure needed to fabricate these batteries to avoid short circuit problems and charging/discharging instability. However, the present design significantly simplifies the battery structure while achieving better battery stability and capacity retention than currently available microbatteries with a similar degree of safety and reliability.

The present technology also offers a number of economic advantages. The technology can be implemented to fabricate microbatteries with significantly lower cost compared to the current available batteries in the market. This is attributable to the low cost of the precursor materials used, as well as the low fabrication cost, which eliminates the use of high vacuum and complicated sacrificial templates. Also, the technology can be implemented to easily print batteries on flexible and irregular surfaces, which makes it more cost effective compared to conventional battery fabrication methods.

### EXAMPLES

### Example 1. Preparation of the PPy/LiFePO₄ Cathode

(LiFePO₄)₁₋ₓ(PPy)ₓ composite cathodes, where x is the weight fraction of PPy, were fabricated by in situ electrodeposition. Carbon coated LiFePO₄ (MSE Supplies, Arizona, USA) was used as received, XRD analysis has been performed to confirm the powder quality. PPy/LiFePO₄ composite films were electrochemically deposited in electrolyte solution of 0.1 M pyrrole monomer (Sigma Aldrich, USA) in anhydrous acetonitrile solution (Sigma Aldrich) containing 0.1 M of lithium perchlorate (Sigma Aldrich), (20, 25, 30, and 35 mg) of LiFePO₄ powder was added to the solution to prepare 4 different PPy/LiFePO₄ electrolyte concentrations used in this study. The suspension was then sonicated for 30 mins immediately before deposition. After that, electrodeposition was performed inside an argon filled glove box, where the interdigitated Au or Au/Ni contacts were used as working electrode, whereas Pt and Ag/AgCl electrodes were used as counter and reference electrodes, respectively. The deposition was performed by cycling the potential at 100 mV Sec⁻¹ rate, from −0.5 to 1.4 V vs. Ag/AgCl. Stirring was conducted during deposition to ensure homogeneous deposition during each cycle. After the electrodeposition was finished, the sample were carefully washed by acetonitrile to clean the surface and remove any residues that may be existing in-between the contacts, the substrate was then left to dry.

### Example 2. Preparation of the Li Anode

After finishing the cathode electrode preparation, the sample was placed in a small polypropylene cell container designed and 3D printed for this process. Freshly scraped Li metal was used as counter and reference electrode, whereas the anode contacts interdigitated electrodes were used as working electrodes, the spacing between the electrodes inside the cell was about 2 mm. the cell was then filled by electrolyte (1.0 M LiPF₆ in EC/EDC, with 1% vinyl carbonate, and 10% fluoroethylene carbonate additive). The cell was then sealed and galvanostatic deposition of lithium was carried out at 40 μA cm⁻² and the deposition continued until 1 mAh cm⁻² capacity of Li metal was applied. The sample was then removed from the cell container and cleaned with ethylene dichloride (EDC) solvent.

### Example 3. Preparation of Solid-State Electrolyte

PEO (M.W 400, 000, Sigma Aldrich) and LiTFSI (Sigma Aldrich) was mixed with EO/Li ratio=12. Appropriate amount of Al₂O₃ (30 nm, Macklin Inc.) was then added to the mixture and dissolved together in acetonitrile solution and stirred for 24 hrs. After the solution became thicker due to solvent evaporation, the slurry was cast using doctor blade on polytetrafluorethylene substrate. The electrolyte was dried in vacuum oven at 45° C. overnight. In order to prepare a separate membrane electrode cell for comparison purposes, after depositing the cathode and anode electrodes, the SSE coated PTFE substrate was pressed to the electrodes' substrate using a hydraulic press at 1 MPa, then the cell was tested after that under this applied pressure. In order to obtain cathode supported electrolyte, the electrolyte slurry was cast into the cathode electrode using dip coating at withdraw speed of 5 mm/min, the supported cathode was then left to dry and then heated at 45° C. overnight in vacuum to remove any solvent residues.

### Example 4. Electrochemical Characterization

The cyclic voltammetry, EIS measurements, and Galvanostatic cycling tests were all conducted using a Biologic VMP3 potentiostat. The areal mass loading for the microbattery was calculated using the micro-cell electrode dimensions and using the TGA mass analysis performed on the LiFePO₄—C composite. The cells were tested at 45° C., where the separate electrode cell was tested under 1 MPa applied pressure to confirm intimate contact between the polymer SSE electrolyte and the electrodes' substrate. All tests were conducted inside argon filled glovebox with H₂O and O₂ concentrations of less than 0.1 ppm.

U.S. Pat. No. 9,388,047 is incorporated herein by reference in its entirety.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

1. Wang, Z. L., Self-powered nanosensors and nanosystems. Wiley Online Library: 2012.
2. Koomey, J. G.; Matthews, H. S.; Williams, E. Annual Review of Environment and Resources 2013, 38.
3. Kyeremateng, N. A.; Brousse, T.; Pech, D. Nature nanotechnology 2017, 12, (1), 7-15.
4. Wang, Y.; Liu, B.; Li, Q.; Cartmell, S.; Ferrara, S.; Deng, Z. D.; Xiao, J. Journal of Power Sources 2015, 286, 330-345.
5. Sun, P.; Li, X.; Shao, J.; Braun, P. V. Advanced Materials 2021, 33, (1), 2006229.
6. Braun, P. V.; Nuzzo, R. G. Nature nanotechnology 2014, 9, (12), 962-963.
7. Liu, Q.; Zhang, G.; Chen, N.; Feng, X.; Wang, C.; Wang, J.; Jin, X.; Qu, L. Advanced Functional Materials 2020, 30, (38), 2002086.
8. Ni, J.; Li, L. Advanced Materials 2020, 32, (28), 2000288.
9. Cheah, S. K.; Perre, E.; Rooth, M.; Fondell, M.; Harsta, A.; Nyholm, L.; Boman, M.; Gustafsson, T.; Lu, J.; Simon, P. Nano letters 2009, 9, (9), 3230-3233.
10. Dudney, N. J.; Neudecker, B. J. Current Opinion in Solid State and Materials Science 1999, 4, (5), 479-482.
11. Chen, S.; Niu, C.; Lee, H.; Li, Q.; Yu, L.; Xu, W.; Zhang, J.-G.; Dufek, E. J.; Whittingham, M. S.; Meng, S. Joule 2019, 3, (4), 1094-1105.
12. Oudenhoven, J. F.; Baggetto, L.; Notten, P. H. Advanced Energy Materials 2011, 1, (1), 10-33.
13. Long, J. W.; Dunn, B.; Rolison, D. R.; White, H. S. Chemical Reviews 2004, 104. (10), 4463-4492.
14. Chai, Z.; Abbasi, S. A.; Busnaina, A. A. Nanotechnology 2019, 30, (48), 485203.
15. Chai, Z.; Jeong, H.; Abbasi, S. A.; Busnaina, A. A. Applied Physics Letters 2019, 114, (10), 103301.
16. Abbasi, S. A.; Chai, Z.; Busnaina, A. Advanced Materials Interfaces 2019, 6, (21), 1900898.
17. Chai, Z.; Seo, J.; Abbasi, S. A.; Busnaina, A. ACS nano 2018, 12, (12), 12315-12323.
18. Boyano, I.; Blazquez, J. A.; de Meatza, I.; Bengoechea, M.; Miguel, O.; Grande, H.; Huang, Y.; Goodenough, J. B. Journal of Power Sources 2010, 195, (16), 5351-5359.
19. Park, K. S.; Schougaard, S. B.; Goodenough, J. B. Advanced materials 2007, 19, (6), 848-851.
20. Huang, Y.-H.; Park, K.-S.; Goodenough, J. B. Journal of the Electrochemical Society 2006, 153, (12), A2282.
21. Downard, A.; Pletcher, D. Journal of electroanalytical chemistry and interfacial electrochemistry 1986, 206, (1-2), 139-145.
22. Tüken, T.; Yazici, B.; Erbil, M. Progress in organic coatings 2004, 51, (2), 152-160.
23. Ahn, S.; Kim, Y.; Kim, K. J.; Kim, T. H.; Lee, H.; Kim, M. H. Journal of power sources 1999, 81, 896901.
24. Majid, S. PloS one 2016, 11, (5), e0154566.
25. Gunawan, I.; Ginting, J.; Yustinus, P. In Preparation of LifePO4 added PPy as cathode materials for Ii-ion battery, IOP Conference Series: Materials Science and Engineering, 2018; IOP Publishing: p 012055.
26. Miao, C.; Bai, P.; Jiang, Q.; Sun, S.; Wang, X. Journal of Power Sources 2014, 246, 232-238.
27. Jagadale, A.; Kumbhar, V.; Lokhande, C. Journal of colloid and interface science 2013, 406, 225230.
28. Dubal, D.; Dhawale, D.; Gujar, T.; Lokhande, C. Applied Surface Science 2011, 257, (8), 33783382.
29. Ji, W.; Ji, J.; Cui, X.; Chen, J.; Liu, D.; Deng, H.; Fu, Q. Chemical Communications 2015, 51, (36), 7669-7672.
30. Li, L.; Basu, S.; Wang, Y.; Chen, Z.; Hundekar, P.; Wang, B.; Shi, J.; Shi, Y.; Narayanan, S.; Koratkar, N. Science 2018, 359, (6383), 1513-1516.
31. Lu, Y.; Tu, Z.; Archer, L. A. Nature materials 2014, 13, (10), 961-969.
32. Tikekar, M. D.; Choudhury, S.; Tu, Z.; Archer, L. A. Nature Energy 2016, 1, (9), 1-7.
33. Lin, D.; Liu, Y.; Cui, Y. Nature nanotechnology 2017, 12, (3), 194.
34. Hafez, A. M.; Jiao, Y.; Shi, J.; Ma, Y.; Cao, D.; Liu, Y.; Zhu, H. Advanced Materials 2018, 30, (30), 1802156.
35. Liu, Y.; Liu, Q.; Xin, L.; Liu, Y.; Yang, F.; Stach, E. A.; Xie, J. Nature Energy 2017, 2, (7), 1-10.
36. Liang, X.; Pang, Q.; Kochetkov, I. R.; Sempere, M. S.; Huang, H.; Sun, X.; Nazar, L. F. Nature Energy 2017, 2, (9), 1-7.
37. Zachman, M. J.; Tu, Z.; Choudhury, S.; Archer, L. A.; Kourkoutis, L. F. Nature 2018, 560, (7718), 345-349.
38. Yan, K.; Lu, Z.; Lee, H.-W.; Xiong, F.; Hsu, P.-C.; Li, Y.; Zhao, J.; Chu, S.; Cui, Y. Nature Energy 2016, 1, (3), 1-8.
39. Zhang, Q.; Lu, Y.; Miao, L.; Zhao, Q.; Xia, K.; Liang, J.; Chou, S. L.; Chen, J. Angewandte Chemie International Edition 2018, 57, (45), 14796-14800.
40. Hafez, A. M.; Sheng, J.; Cao, D.; Chen, Y.; Zhu, H. ES Energy & Environment 2019, 5, 85-93.
41. Shen, Y.; Zhang, Y.; Han, S.; Wang, J.; Peng, Z.; Chen, L. Joule 2018, 2, (9), 1674-1689.
42. Zhang, X. Q.; Cheng, X. B.; Zhang, Q. Advanced Materials Interfaces 2018, 5, (2), 1701097.
43. Gao, H.; Xin, S.; Xue, L.; Goodenough, J. B. Chem 2018, 4, (4), 833-844.
44. Knauth, P. Solid State Ionics 2009, 180, (14-16), 911-916.
45. Jiang, Z.; Xie, H.; Wang, S.; Song, X.; Yao, X.; Wang, H. Advanced Energy Materials 2018, 8, (27), 1801433.
46. Chen, X.; He, W.; Ding, L.-X.; Wang, S.; Wang, H. Energy & Environmental Science 2019, 12, (3), 938-944.

1. A solid state battery comprising:
(i) an electrically insulating substrate;
(ii) first and second conductive contact layers deposited on the substrate, the first contact layer having a first pattern, and the second contact layer having a second pattern;
(iii) a cathode layer deposited on the first contact layer and conforming to the first pattern;
(iv) an anode layer deposited on the second contact layer and conforming to the second pattern;
(v) a solid electrolyte supported by the cathode layer, wherein the cathode layer is infiltrated with the solid electrolyte.

2. The battery of claim 1, wherein the first and second patterns are interdigitated.

3. The battery of claim 1, wherein the cathode layer is a composite comprising carbon coated lithium iron phosphate (CLiFePO₄) nanoparticles or microparticles embedded in a polymer matrix.

4. The battery of claim 3, wherein the polymer matrix comprises polypyrrole (PPy) or a derivative thereof.

5. The battery of claim 1, wherein the anode layer comprises a metal selected from the group consisting of lithium, zinc, and nickel.

6. The battery of claim 1, wherein the solid electrolyte comprises polyethylene oxide.

7. The battery of claim 1, wherein the first and/or second conductive contact layers comprise a metal or metal alloy selected from the group consisting of gold, gold alloys, and nickel/gold alloys.

8. The battery of claim 1, wherein the substrate comprises silicon dioxide, glass, silicon, or a non-conductive polymer.

9. The battery of claim 1, wherein the substrate is flexible or rigid.

10. The battery of claim 1 that is a microbattery.

11. The battery of claim 1 that is rechargeable for at least 200 charging cycles with loss of not more than 30%, not more than 25%, not more than 20%, not more than 15%, not more than 10%, not more than 5%, not more than 2%, or not more than 1% of its original capacity.

12. The battery of claim 1, wherein the first and second contact layers comprise a NI/Au alloy, wherein the first and second patterns are interdigitated, wherein the cathode layer comprises carbon coated lithium iron phosphate (CLiFePO₄) nanoparticles or microparticles embedded in a PPy polymer matrix, wherein the anode layer comprises lithium metal, and wherein the solid electrolyte comprises polyethylene oxide.

13. The battery of claim 1, wherein the battery has a discharge capacity of at least about 157 mA h g⁻¹ at 35° C. and a cycling stability of at least about 78% capacity retention and 99.7% coulombic efficiency after 200 cycles.

14. An electronic device comprising the battery of claim 1.

15. The electronic device of claim 14 which is a sensor, a biosensor, a biomedical sensor, an RFID tag, a device for use in the Internet of Things, a wearable electronic item, a flexible electronic device, or a micro actuator.

16. A method of fabricating a solid state battery, the method comprising the steps of:
(a) depositing first and second interdigitated conductive contact layers onto a surface of an insulating substrate, the first contact layer having a first pattern, and the second contact layer having a second pattern;
(b) depositing a self-assembling monolayer onto the substrate at exposed areas not covered by the first and second conductive contact layers;
(c) depositing a cathode layer onto the first conductive contact layer by electrodeposition using cyclic voltammetry to form a cathode;
(d) removing the self-assembled monolayer;
(e) depositing an anode film onto the second conductive contact layer by electroplating to form an anode;
(f) depositing a solid electrolyte layer by dip coating the structure resulting from (e) in a suspension of solid electrolyte particles and drying the resulting covered structure to form the solid state battery, whereby a portion of the solid electrolyte particles become embedded in the cathode layer.

17. The method of claim 16, wherein the first and second patterns are interdigitated.

18. The method of claim 16, further comprising, between steps (a) and (b):
(a1) silanizing said substrate surface on all areas outside of the first and second contact layers.

19. The method of claim 18, wherein the self-assembled monolayer comprises an alkyl-terminated silane.

20. The method of claim 16, wherein the self-assembled monolayer is removed in step (d) by exposure to an oxygen plasma.

21. The method of claim 16, wherein the solid electrolyte layer forms continuous contact with the entire surface of the cathode layer and the entire surface of the anode layer and fills spaces between the cathode and the anode to form a completely solid structure.

22. The method of claim 16, wherein the electrodeposition of step (c) comprises use of an electrolyte solution comprising carbon coated LiFePO₄ nanoparticles, pyrrole monomer, and lithium perchlorate.

23. The method of claim 16, wherein step (e) comprises electroplating lithium metal onto the second conductive contact layer.

24. The method of claim 16, wherein the suspension of solid electrolyte particles in step (f) comprises polyethylene oxide nanoparticles suspended in acetonitrile.
